(19) United States
(12) Patent Application Publication
(10) Pub. No.: US 2015/0135664 A1
(43) Pub. Date: May 21, 2015

(54) COALESCERS WITH MESHED COALESCING MEDIA

(71) Applicant: BHA Altair, LLC, Franklin, TN (US)

(72) Inventors: Etienne Rene Jarrier, Basingstoke (GB); Evdokia Ivanova Justice, Winchester (GB); Paul Sherwood Bryant, Amesbury (GB); Alan Edwin Baigent, Petersfield (GB); Stephen David Hiner, Salisbury (GB)

(73) Assignee: BHA Altair, LLC, Franklin, TN (US)

(21) Appl. No.: 14/083,128

(22) Filed: Nov. 18, 2013

(51) Int. Cl. B01D 46/00

(52) U.S. Cl. CPC B01D 46/003; B01D 46/0005; B01D 46/0019
USPC 55/482; 55/501

(57) ABSTRACT

A coalescer includes a frame with at least one crossmember for securing a flexible coalescing net assembly. The coalescing net assembly is disposed across openings in the frame for capturing moisture in air flowing through the coalescer. The coalescing net assembly has an area greater than the frame area for increasing coalescing efficiency.

### BACKGROUND OF THE INVENTION

The subject matter disclosed herein relates to gas turbine air filtration, in particular, to coalescers that remove free form moisture, or droplets, from intake air used by the gas turbine.

Generally, gas turbine filtration enclosures and systems that are situated in relatively dry, desert regions are challenged by a combination of relatively high dust, particulate and contaminant loads along with local environmental conditions that can include heavy fog periods. The combination of these can prove challenging for final, high efficiency filters even with pulse cleaning systems installed. This is because the combination of conditions can create a mud-like cake on the filters that shortens their operational life.

The traditional and existing approach to solving this issue is to use coalescers and air filters upstream of the final high efficiency filters as a low cost, cleanable protection system for the more expensive final filters. The coalescers may, however, require intensive maintenance with frequent change out periods due to the high pressure drops created by clogged coalescers. One factor that contributes to the clogging of coalescers used in the first stage of air filtration systems is that the coalescers capture both dirt and moisture which accelerates clogging. Another factor is that the surface area presented by the coalescers to the intake air is inadequate to efficiently remove moisture from the volume of air passing through the coalescers. Accordingly, there is a need for coalescers having increased surface area that efficiently remove moisture from intake air without causing excessive pressure drops.

The discussion above is merely provided for general background information and is not intended to be used as an aid in determining the scope of the claimed subject matter.

### BRIEF DESCRIPTION OF THE INVENTION

A coalescer includes a frame with at least one crossmember for securing a flexible coalescing net assembly. The coalescing net assembly is disposed across openings in the frame for capturing moisture in air flowing through the coalescer. An advantage that may be realized in the practice of some disclosed embodiments of the coalescers disclosed herein is improved coalescing efficiency due to a greater coalescing surface area without generating excessive pressure loss.

In one embodiment, a coalescer includes a frame with side, top, and bottom frame members connected together. A crossmember attached to the top and bottom frame members forms frame openings. A coalescing net assembly is disposed across the frame openings to capture moisture in air flowing through the coalescer. The coalescing net assembly has an area greater than the frame area, is attached to the side frame members, and is in contact with the crossmember.

In another embodiment, a coalescer includes a frame with side, top, and bottom frame members. A pair of exterior crossmembers and a number of interior crossmembers are attached to the top and bottom frame members to form frame openings. A coalescing net assembly is disposed across the frame openings to capture moisture in air flowing through the coalescer. The coalescing net assembly has an area greater than the area of the frame, is attached to the pair of exterior crossmembers, and is in contact with the interior crossmembers.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a top cross-sectional diagram of an exemplary coalescer;

FIG. 2 is a side view of the exemplary coalescer of FIG. 1;

FIG. 3 is a front view of the exemplary coalescer of FIG. 1;

FIG. 4 is a top cross-sectional diagram of another exemplary coalescer;

FIG. 5 is a side view of the exemplary coalescer of FIG. 4; and

FIG. 6 is a front view of the exemplary coalescer of FIG. 4.

### DETAILED DESCRIPTION OF THE INVENTION

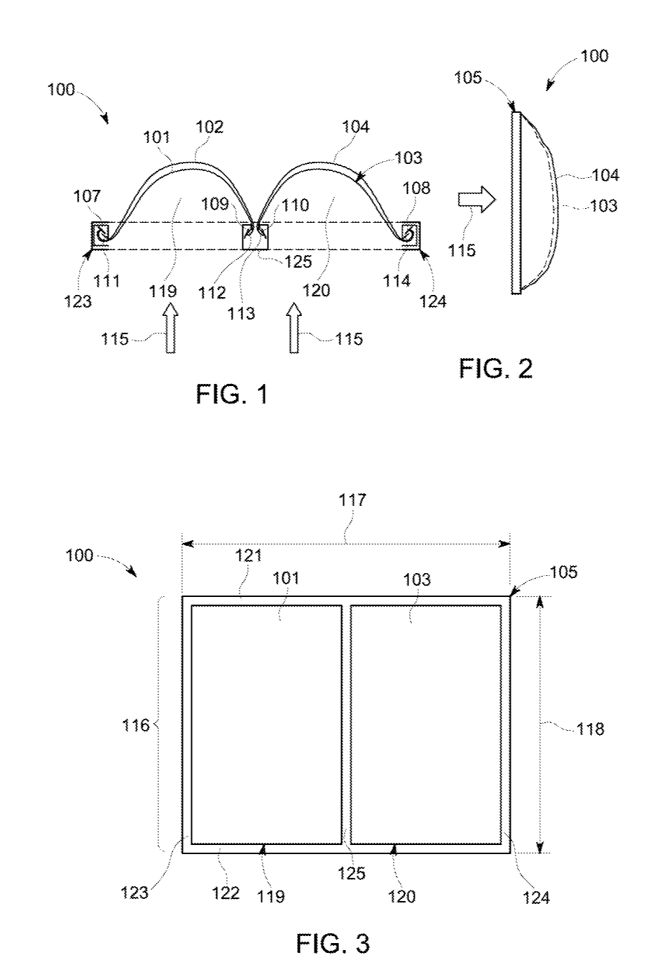

With reference to FIGS. 1-3, a coalescer 100 is provided as an upstream air treatment assembly in a gas turbine or other industrial application requiring moisture filtration. The coalescer 100 includes a frame 105 having parallel top and bottom frame members 121, 122 attached to parallel side frame members 123, 124. The frame 105 surrounds a frame intake area 116 generally defined by a frame width 117 and a frame height 118. A central frame member, or crossmember, 125 is attached to the top and bottom frame members 121, 122 between the side frame members 123, 124 to divide the frame intake area 116 into two frame openings 119, 120. Coalescing nets 101, 102, 103, 104 are attached to the top and bottom frame members 121, 122, the side frame members 123, 124, and to the crossmember 125. The top and bottom frame members 121, 122 are attached to the side frame members 123, 124 at their ends to form a substantially rigid or semi-rigid frame 105 made from, for example, a plastic or metal. The frame members 121-125 may be formed in a hollow configuration, as explained below, for securing the coalescing nets 101-104 therein.

The coalescer 100, in particular, the coalescing nets 101-104, serve to coalesce relatively fine mist, droplets, fog, and moisture from an air flow entering through a front side of the coalescer 100 in the direction indicated by the arrows 115. As the coalescing nets 101-104 become wet with water as more moisture is trapped, the water is gravitationally removed from the coalescing nets 101-104 by a draining movement of the water downward toward the bottom of the coalescing nets 101-104. The coalescing nets 101-104 permit dust to pass through, however, and thus do not become easily clogged. Where dust is captured by the coalescing nets 101-104, it is carried toward the bottom of the coalescing nets 101-104 by the water draining downward.

As shown in FIGS. 1-3, coalescing nets 101-104 are attached at their edges to the frame 105. With reference in particular to FIG. 1, the coalescing nets 101-104 may be attached to the frame members 121-125 by means of outside tabs 107, 108, and inside tabs 109, 110 that are attached to corresponding edges of the coalescing nets 101-104 to form first and second coalescing net assemblies. The first coalescing net assembly comprises outside tab 107 and inside tab 109 attached to coalescing net 101 together with outside tab 108 and inside tab 110 attached to coalescing net 103. The second coalescing net assembly comprises outside tab 107 and inside tab 109 attached to coalescing net 102 together with outside tab 108 and inside tab 110 attached to coalescing net 104. Thus, each of the first and second coalescing net assemblies is disposed across the first and second frame openings 119, 120. The first coalescing net assembly may be said to have a first portion disposed across the first frame opening 119 and a second portion disposed across the second frame opening 120. Similarly, the second coalescing net assembly may be said to have a first portion disposed across the first frame opening 119 and a second portion disposed across the second frame opening 120.

The outside tabs 107, 108 are inserted into the hollow side frame members 123, 124, respectively, and the inside tabs 109, 110 are inserted into the hollow crossmember 125. Similarly, although not shown, top and bottom edges of the coalescing nets 101-104 are attached to tabs that are inserted into the top and bottom frame members 121, 122. The side frame members 123, 124 include protrusions 111, 114 therein for locking the tabs 107, 108, respectively, in place inside the side frame members 123, 124. The crossmember 125 includes similar protrusions 112, 113 therein, for locking the tabs 109, 110, respectively, in place inside the crossmember 125. Similarly, although not shown, top and bottom frame members 121, 122 include protrusions for locking the tabs that are attached to the top and bottom edges of the coalescing nets 101-104. Thus, the first and second coalescing net assemblies comprising the coalescing nets 101-104 attached to tabs 107-110 are fastened to the frame members 121-125 for securing the coalescing nets 101-104 in the air flow indicated by arrows 115. In particular, the coalescing nets 101-104 are held in position when the coalescing nets 101-104 are under tension caused by the incoming airflow. In the exemplary embodiments of FIGS. 1-3, the coalescer 100 does not leave significant gaps, such as between the coalescing nets 101-104 and the frame 105, wherein the air flow indicated by arrows 115 might bypass the coalescing nets 101-104.

The coalescing nets 101-104 may be said to have a width and height that is greater than the frame width 117 and frame height 118 to provide a coalescer that allows the coalescing nets 101-104 to billow when air flows through the coalescer 100. The coalescing nets 101-104 are secured to the frame members 121-125 such that the coalescing nets 101-104 are permitted to billow and move independently within the airflow, indicated by arrows 115, traveling therethrough. The coalescing nets 101-104 may each be secured to the frame members 121-125 under similar tension or under different tensions. In order to maintain a separation between the coalescing nets 101 and 102, and between the coalescing nets 103 and 104, and thereby improve their coalescing capacity, coalescing net 101 comprises less material along its height and width as compared with the coalescing net 102. Similarly, coalescing net 103 comprises less material along its height and width as compared with the coalescing net 104. Thus, the area of coalescing net 102 is greater than the area of coalescing net 101, and the area of coalescing net 104 is greater than the area of coalescing net 103. It follows then, that the areas of coalescing nets 101, 102 are each greater than the area of frame opening 119, and the areas of coalescing nets 103, 104 are each greater than the area of frame opening 120. In one embodiment, the coalescing nets 101-104 each comprise an area that is greater than the area of its corresponding frame opening 119, 120 by at least about 150%.

A person skilled in the art will appreciate that the coalescer 100 may have various configurations other than those shown in FIGS. 1-3. For example, the coalescer 100 may include only one coalescing net across each of the frame openings 119, 120, such as coalescing nets 101 and 103, which comprise the first coalescing net assembly, as described above. The coalescer 100 may, alternatively, include three or more coalescing nets across each frame opening 119, 120, which would comprise three or more coalescing net assemblies. The coalescing nets 101 and 103 may also be formed as one single continuous coalescing net spanning the frame area 116 from side frame member 123 to side frame member 124. Such a single continuous coalescing net may be secured in fixed contact to a front side or back side of the crossmember 125, or it may, alternatively, not be in fixed contact with the crossmember 125 and may freely slide over the front side of the crossmember 125, for example. Similarly, the coalescing nets 102 and 104 may be formed as one single continuous coalescing net spanning the frame area 116 from side frame member 123 to side frame member 124 in fixed or non-fixed contact with the crossmember 125.

Moreover, the coalescer 100 may include two or more crossmembers 125 connected to the top and bottom frame members 121, 122 to form three or more frame openings similar to the frame openings 119, 120. Each of those frame openings may have one or more coalescing net assemblies disposed thereacross. The coalescing nets 101-104 may be attached to frame members 121-125 using suitable means other than the locking tabs 107-110 described herein. For example, the frame members 121-125 may be formed from solid rods and the coalescing nets 101-104 may be attached thereto using adhesives, ties, or other suitable fastening means. Thus, the coalescer 100 may include any combination of features disclosed herein and known in the art.

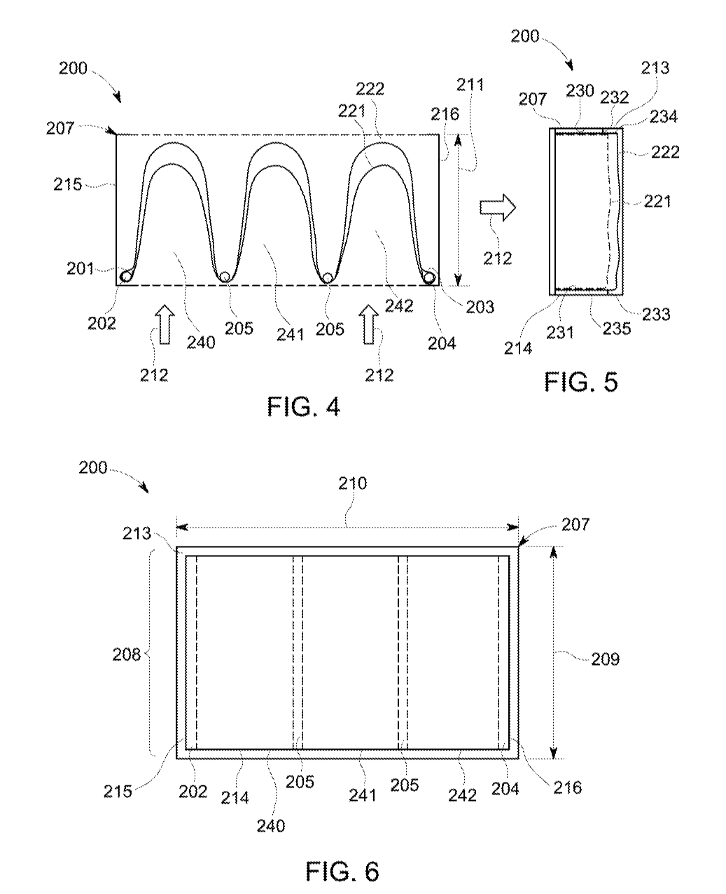

With reference to FIGS. 4-6, a coalescer 200 is provided as an upstream air treatment assembly for a gas turbine or other industrial application requiring moisture filtration. The coalescer 200 includes a frame 207 having parallel top and bottom frame members, or panels, 213, 214 attached to parallel side frame members, or panels, 215, 216. The top and bottom frame members 213, 214 are attached to the side frame members 215, 216 at their ends to form a substantially rigid or semi-rigid frame 207 made from, for example, a plastic or metal. The frame 207 surrounds a frame intake area 208 generally defined by a frame height 209 and a frame width 210. The frame 207 also comprises a frame depth 211. The coalescer 200 includes exterior crossmembers 202, 204 and interior crossmembers 205 that are each connected to the top and bottom frame members 213, 214, across the intake area 208 between the side frame members 215, 216. The interior crossmembers 205 divide the frame intake area 208 into three frame openings 240, 241, 242. Coalescing nets 221, 222 are attached to the exterior crossmembers 202, 204, thereby forming first and second coalescing net assemblies across the frame openings 240-242 in the frame area 208. The coalescing nets are in non-fixed contact with interior frame members 205 as an air flow indicated by arrows 212 travels therethrough. This allows the coalescing nets 221, 222 to slide across the front side of the interior crossmembers 205.

The coalescer 200, in particular, the coalescing nets 221, 222, serve to coalesce relatively fine mist, droplets, fog, and moisture from an air flow entering through a front side of the coalescer 200 in the direction indicated by arrows 212. As the coalescing nets 221, 222 become wet with water as more moisture is trapped, the water is gravitationally removed from the coalescing nets 221, 222 by a draining movement of the water downward toward the bottom edges 235 of the coalescing nets 221, 222. The coalescing nets 221, 222 permit dust to pass through, however, and thus do not become easily clogged. Where dust is captured by the coalescing nets 221, 222, it is carried toward the bottom edges 235 of the coalescing nets 221, 222 by the water draining downward.

As shown in FIGS. 4-6, the coalescing nets 221, 222 are attached at their vertical edges to the exterior crossmembers 202, 204. With reference in particular to FIG. 4, the coalescing nets 221, 222 may be attached to exterior crossmembers 202, 204 by forming a coalescing net loop 201, 203 at each of the vertical edges of the coalescing nets 221, 222 and wrapping the coalescing net loops 201, 203 around the exterior crossmembers 202, 204, respectively, as shown in FIG. 4, to form first and second coalescing net assemblies. The first coalescing net assembly comprises exterior crossmembers 202, 204 attached to coalescing net 221. The second coalescing net assembly comprises exterior crossmembers 202, 204 attached to coalescing net 222. Thus, each of the first and second coalescing net assemblies is disposed across the three frame opening 240-242. The first coalescing net assembly may be said to have a first portion disposed across the frame opening 240, a second portion disposed across the frame opening 241, and a third portion disposed across the frame opening 241. Similarly, the second coalescing net assembly may be said to have a first portion disposed across the frame opening 240, a second portion disposed across the frame opening 241, and a third portion disposed across the frame opening 241.

The coalescing nets 221, 222 generally comprise a width that is about three times the width 210 of the frame 207. The coalescing nets 221-222 may be said to have a width that is greater than the frame width 210 to provide a coalescer that allows the coalescing nets 221-222 to billow when air flows through the coalescer 200. The coalescing nets 221-222 may each be secured to the external crossmembers 202-204 under similar tension or under different tensions. In order to maintain a separation between the coalescing nets 221 and 222, and thereby improve their coalescing capacity, coalescing net 221 comprises less material along its width as compared with the coalescing net 222. Thus, the area of coalescing net 222 is greater than the area of coalescing net 221. It follows then, that the areas of coalescing nets 221, 222 are each greater than the frame area 208. Also, the areas of the first, second, and third portions of each of the coalescing nets 221, 222 are greater than the areas of the corresponding frame openings 240-242. In one embodiment, the coalescing nets 221-222 each comprise an area that is greater than the frame area 208 by at least about 200%.

While the coalescing nets 221, 222 are permitted to move freely within the frame 207, the height 209 of the frame 207 is selected to minimizes a gap 232 as between the top edges 234 of the coalescing nets 221, 222 and the interior top surface 230 of the frame 207, as well as minimize a gap 233 as between the bottom edges 235 of the coalescing nets 221, 222 and the interior bottom surface 231 of the frame 207. The crossmembers 202-205 secure the coalescing nets 221, 222 in position within the air flow indicated by arrows 212. In particular, when the coalescing nets 221, 222 are under tension caused by the incoming airflow, the coalescing nets 221, 222 may be free to billow and move independently within the frame 207. In one embodiment, the sizes of the coalescing nets 221, 222 and the frame depth 211 are configured such that the coalescing nets 221, 222 do not billow beyond the frame depth 211. The coalescing nets 221, 222 may be in non-fixed contact with the interior crossmembers 205 or they may be in fixed contact with the interior crossmembers 205 by attaching them to the interior crossmembers 205 along the height of the coalescing nets 221, 222 and along the height of the crossmembers 205, such as by clamping, tying, or hooking the coalescing nets 221, 222 thereto.

A person skilled in the art will appreciate that the coalescer 200 may have various configurations other than those shown in FIGS. 4-6. For example, the coalescer 200 may include only one coalescing net across each of the frame openings 240-242, such as coalescing net 221, which is comprised in the first coalescing net assembly. The coalescer 200 may, alternatively, include three or more coalescing nets across each frame opening 240-242, which would comprise three or more coalescing net assemblies. The coalescing nets 221, 222 may also be formed as separate pieces each spanning a single one of the frame openings 240-242 and attached between interior crossmembers 205, for example, or between an interior crossmember 205 and an exterior crossmember 202, 204.

Moreover, the coalescer 200 may include only one interior crossmember 205 connected to the top and bottom frame members 213, 214 to form two frame openings similar to the frame openings 240-242. Each of those frame openings may have one or more coalescing net assemblies disposed thereacross. The coalescing nets 221-222 may be attached to exterior crossmembers 202, 204 using suitable means other than the coalescing net loops 201, 203 described herein. For example, the coalescing nets 221-222 may be attached thereto using adhesives, ties, hooks, clamps, or other suitable fastening means. In addition, the coalescer 200 may include three or more interior crossmembers 205, wherein each of the additional interior crossmembers 205 supports the one or several coalescing nets 221, 222 as described herein. Thus, the coalescer 200 may include any combination of features disclosed herein and known in the art.

As illustrated herein, the coalescing assemblies 100, 200 may be positioned in a conduit of an air treatment system for de-moisturizing air to be used in downstream industrial applications, such as a gas turbine. The frame 105 of the coalescer 100 may be sealingly positioned in an opening of a single conduit, or in a frame containing a plurality of openings within which a number of coalescers 100 may be disposed. Similarly, the frame 207 of the coalescer 200 may be positioned in an opening of a single conduit or in a system of coalescing assemblies 200.

The coalescing nets 101-104 and 221, 222 described above with respect to coalescing assemblies 100, 200, respectively, may be formed of a raschel weave, or raschel knit, having a lacelike, open construction of a relatively heavy, textured yarn held in place by a much finer yarn, a shade net type with shading values from about 35% to about 80%, for example, or similar net types. Air flow through the coalescing nets 101-104, 221, 222, may cause a relative movement as much as half the height or length thereof, and may lead to a billowing, wave-like or turbulent movement of the coalescing nets 101-104, 221, 222.

The coalescing of moisture may occur at either or all of the coalescing nets 101-104 or 221, 222. The frame 105, and its crossmember(s) 125, which secure the coalescing nets 101-104 may be disposed substantially perpendicularly with respect to a predominant direction of the airflow indicated by arrows 115. Similarly, the frame 207, its interior crossmembers 205, and its exterior crossmembers 202, 204, which secure the coalescing nets 221, 222, may be disposed substantially perpendicularly with respect to a predominant direction of the airflow indicated by arrows 212. In some embodiments, the coalescing nets 101-104 and 221, 222 may be disposed at another angle with respect to the airflows, but sufficiently vertical whereby gravitational drainage of coalesced moisture is encouraged and/or facilitated.

In view of the foregoing, embodiments of the invention provide an efficient moisture removal assembly without causing an excessive pressure drop in the incoming air flows. A technical effect is to provide demoisturized air for improved performance of industrial machinery, such as gas turbines.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A coalescer comprising:
a frame comprising a first side frame member, a second side frame member parallel to the first side frame member, a top frame member, and a bottom frame member parallel to the top frame member, the frame members defining a frame area;
a crossmember attached to the top and bottom frame members to form a first frame opening and a second frame opening; and
a first coalescing net assembly disposed across the first and second frame openings for capturing moisture in air flowing through the coalescer, wherein the first coalescing net assembly is attached to the first and second side frame members and is in contact with the crossmember, and wherein the first coalescing net assembly has an area greater than the frame area.

2. The coalescer of claim 1, wherein the first coalescing net assembly is in fixed contact with the crossmember.

3. The coalescer of claim 2, wherein the first coalescing net assembly comprises a first portion attached to the first side frame member, the top frame member, the bottom frame member, and to the crossmember, and a second portion, separate from the first portion, attached to the second side frame member, the top frame member, the bottom frame member, and to the crossmember.

4. The coalescer of claim 3, wherein the first and second portions of the first coalescing net assembly each has an area greater than the first and second frame openings, respectively.

5. The coalescer of claim 4, wherein the first and second portions of the first coalescing net assembly each has an area at least about 150% greater than the first and second frame openings, respectively.

6. The coalescer of claim 1, wherein the first coalescing net assembly comprises a raschel weave.

7. The coalescer of claim 3, further comprising a second coalescing net assembly disposed across the first and second frame openings for capturing moisture in air flowing through the coalescer, wherein the second coalescing net assembly is attached to the first and second side frame members and to the top and bottom frame members, is in fixed contact with the crossmember, and wherein the second coalescing net assembly has an area greater than the area of the first coalescing net assembly.

8. The coalescer of claim 1, wherein the first coalescing net assembly comprises a single continuous net disposed across the first and second frame openings.

9. The coalescer of claim 8, further comprising a second coalescing net assembly disposed across the first and second frame openings for capturing moisture in air flowing through the coalescer, wherein the second coalescing net assembly is attached to the first and second side frame members and is in contact with the crossmember, and wherein the second coalescing net assembly has an area greater than the area of the first coalescing net assembly.

10. The coalescer of claim 9, wherein the first coalescing net assembly and the second coalescing net assembly are each in a non-fixed contact with the crossmember.

11. A coalescer comprising:
a frame comprising a first side frame member, a second side frame member parallel to the first side frame member, a top frame member, and a bottom frame member parallel to the top frame member, the frame members defining a frame area;
a pair of exterior crossmembers and a plurality of interior crossmembers, each attached to the top and bottom frame members to form a corresponding plurality of frame openings; and
a first coalescing net assembly disposed across the plurality of frame openings for capturing moisture in air flowing through the coalescer, wherein the first coalescing net assembly is attached to the pair of exterior crossmembers and is in contact with each of the plurality of interior crossmembers, and wherein the first coalescing net assembly has an area greater than the frame area.

12. The coalescer of claim 11, wherein the first coalescing net assembly is in fixed contact with each of the plurality of interior crossmembers.

13. The coalescer of claim 12, wherein the first coalescing net assembly comprises:
a first portion attached to a first exterior crossmember and to one of the interior crossmembers closest to the first exterior crossmember; and
a second portion attached to a second exterior crossmember and to one of the interior crossmembers closest to the second exterior crossmember.

14. The coalescer of claim 13, wherein the first and second portions of the first coalescing net assembly each has an area greater than its corresponding frame opening.

15. The coalescer of claim 14, wherein the first and second portions of the first coalescing net assembly each has an area at least about 200% greater than its corresponding frame opening.

16. The coalescer of claim 11, wherein the first coalescing net assembly comprises a raschel weave.

17. The coalescer of claim 13, further comprising a second coalescing net assembly disposed across the plurality of frame openings for capturing moisture in air flowing through the coalescer, wherein the second coalescing net assembly is attached to the pair of exterior crossmembers and is in fixed contact with each of the interior crossmembers, and wherein the second coalescing net assembly has an area greater than the area of the first coalescing net assembly.

18. The coalescer of claim 11, wherein the first coalescing net assembly comprises a single continuous net disposed across the plurality of frame openings.

19. The coalescer of claim 18, further comprising a second coalescing net assembly disposed across the plurality of frame openings for capturing moisture in air flowing through the coalescer, wherein the second coalescing net assembly is attached to the pair of exterior crossmembers and is in contact with each of the interior crossmembers, and wherein the second coalescing net assembly has an area greater than the area of the first coalescing net assembly.

20. The coalescer of claim 19, wherein the first coalescing net assembly and the second coalescing net assembly are each in a non-fixed contact with each of the interior crossmembers.
